(19) United States
(12) Patent Application Publication
(10) Pub. No.: US 2005/0190756 A1
(43) Pub. Date: Sep. 1, 2005

(54) RTP payload for voice band data transmission

(76) Inventors: Satish Kumar M. Mundra, Germantown, MD (US); David A. Lide, Rockville, MD (US)

Correspondence Address: TEXAS INSTRUMENTS INCORPORATED, P O BOX 655474, M/S 3999, DALLAS, TX, 75265, US

(21) Appl. No.: 10/788,091

(22) Filed: Feb. 26, 2004

(51) Int. Cl. H04L 12/56

(52) U.S. Cl. 370/389

(57) ABSTRACT

A method for defining a payload format in Real Time Protocol (RTP) messages for voice band data transmission to be transmitted over a packet network to an Internet Protocol (IP) telephony endpoint, such as an IP phone. The invention extends RFC 2833 standards for Real Time Protocol (RTP) message payload format to include voice data transmission. The invention includes receiving voice transmission signals containing a voice band data from the public switched telephone network into a packet network and converting said voice transmission signals into data packets using real time protocol (RTP) and assigning an RTP event code in the RTP payload format for the voice band data applications. Applications include Caller Identification (Caller-ID), Visual Message Waiting Indication (VMWI), and Advanced Digital Subscriber Interface (ADSI).

### CROSS-REFERENCE TO RELATED APPLICATIONS

None

### FIELD OF THE INVENTION

The present invention relates generally to a payload format in Real Time Protocol (RTP) messages for voice data information, such as caller-ID, to be transmitted over a packet network to an Internet Protocol (IP) telephony endpoint, such as an IP phone.

### BACKGROUND OF THE INVENTION

Voice over packet networks (VOPN) require that the voice or audio signal be packetized and then transmitted. The analog voice signal is first converted into a digital signal and is typically compressed in the form of a pulse code modulated (PCM) digital stream. In a voice over Internet Protocol (VoIP) network, Line Control Signaling (LCS) defines a standard for packet data transmission architecture. LCS is a description of an IP-based cable telephony service that is an extension of PacketCable 1.0 architecture. PacketCable is a set of protocols for telecommunications using packet data transmissions to a home or business over a cable network. The PacketCable standards for LCS architecture are described in the document “PacketCable Line Control Signaling System Architecture Technical Report” (PKT-TR-ARCH-LCS-V01-010730) by Cable Television Laboratories, Inc., which is incorporated herein.

FIG. 1 illustrates part of the Line Control Signaling System Architecture, which comprises an IPDT (Internet Protocol Digital Terminal) 10 gateway that acts as a thin-CMS (call management server) and provides interworking between PacketCable network 18 and a local digital switch (LDS) 14 in the PSTN (publicly switched telephone network) 12. The Telecordia GR-303 standard is used by communications link 16 between the IPDT 10 and LDS 14. GR-303 switched IP telephony system architecture relies on general PacketCable NCS (Network Based Call Signaling) support for RFC 2833 RTP (Real Time Protocol) Named Telephony Events. The document “RTP Payload for DTMF Digits, Telephony Tones and Telephony Signals,” (RFC 2833) specifies an Internet standards track protocol for the Internet community and defines the payload format for carrying dual-tone multifrequency (DTMF) digits and other line and trunk signals and is incorporated herein. RFC (Request for Comments), is a series of notes about the Internet, started in 1969 (when the Internet was the ARPANET).

The Real Time Protocol (RTP) is an Internet Protocol specified in IETF RFC 3550/3551 for end-to-end network transport functions for applications that provide real-time data transmissions over a unicast or multicast network, such as the Internet. Real-time data is data traffic that needs to be sent and received with only very short delays, in other words nearly instantaneously. RTP encapsulates real time data in a data field of an RTP packet. A header field of an RTP packet contains important information regarding the type of data in the data field. RTP packets carry data that requires playback in a receiving application in a time-sensitive mode. The types of data that use RTP include voice and video data that are sent over packet networks for assembly and playout at the receiver. RTP provides information that is sent with the data to a receiver that includes payload/data type, sequence numbering, packet time-stamping, and delivery monitoring.

On the IP network 26 side of IPDT 10, an IP network through a VoIP gateway 28 and a PacketCable network through network 18 are illustrated in FIG. 1. The LCS System Architecture comprises a DOCSIS (Data Over Cable System Interface Specification) 1.1 Hybrid Fiber Coax (HFC) access network 18 connected to an IP network 26 (e.g., a managed IP backbone) that communicates with PSTN 14 through IPDT 10. Additionally, an end user at a personal computer 30 or IP phone 20 can access PSTN 14 through VoIP gateway 28 that is connected to IPDT 10 through IP network 26. VoIP gateway 28 handles calls from IP phone 20 through broadband IP network 26. Gateway 28 may be located at VoIP service provider's data center or a telephone service company's central office. The gateway 28 connects to the broadband network 26 with a high speed Internet connection 24 such as a digital subscriber line (DSL), cable modem, or T1/T5 line. The PC 30 is connected to VoIP gateway 28 through a network such as Ethernet 32. An IP telephone 20 may connect to gateway 28 through network 32 and a traditional phone 36 may connect through an RJ 11 telephony port 22 on VoIP 28. The broadband IP network 26 comprises a packet-switched network which can also include the public Internet.

A typical packet 38 format for a VOPN is illustrated in FIG. 2. An IP header 40 includes an IP address frame 42, a user datagram protocol (UDP) frame 46, and a Real Time Protocol (RTP) frame 48. UDP serves as an application interface to the IP and since it has no reliability, flow control, or error-recovery capabilities, also serves as a multiplexer/demultiplexer for the receiving and sending of IP traffic. Payload 50 includes multiple frames 52 of voice data.

An RTP data unit is carried in User Datagram Protocol (UDP) and Internet Protocol (IP) data units. The message format 54 for RTP, illustrated in FIG. 3, supports various types of payloads, such as G.711 and video protocols. The fixed header fields of the RTP message format are illustrated in FIG. 3. Bits zero through thirty-one are designated at the top row 56 of the datagram. The fields in layer 58 are defined as follows: the V (“Version”) field occupies the first two bits and represents the RFP version number (e.g., V=2 specifies Version 2.0); the P (“padding”) field occupies bit number two and represents a padding flag to denote if padding octets are added at the end of a message payload which are not part of the payload but may be needed by certain applications; the X (“Extension bit”) field occupies bit number three and denotes when a header from the RTP message if followed by an additional header; the CC (“contributor count”) field occupies bits four through seven and designates how many contributing source identifiers are in the message; the M (“Marker”) field occupies bit number eight and denotes a demarcation boundary for significant events in the data stream and is defined by a profile or specific application; the PT (“Payload Type”) field occupies bits nine through fifteen and denotes the format of the RTP payload in the data field, such as a specific data protocol; the Sequence Number field occupies bits sixteen through thirty-one and is a number that increments by one for each RTP data packet sent that be used by a receiver to determine if a packet loss occurs or to re-assemble packets received out of sequence. The next layer 60 is the Timestamp that denotes the sampling instant of the first octet in the RTP data packet, which must be derived from a clock that increments monotonically and linearly in time to allow synchronization and jitter calculations. The layer 62 is the Synchronization Source Identifier (SSRC) that is chosen randomly with the intent that no two synchronization sources in the same RTP session will have the same identifier. The CSRC layer 64 defines a variable Contributing Source Identifiers list that identifies the contributing sources for the payload contained in the current packet. The next layer 66 is the Data field that carries a variable data payload of the packet.

Dialpad tone signals from the PSTN may be generated through a gateway prior to transmission to an IP phone. The payload formats described in RFC 2833 are useful for DTMF handling in gateways and end systems. For IP telephony, the standard specifies detecting DTMF tones by a gateway on incoming circuits and sending RTP payloads instead of regular audio packets. By using RFC 2833 for DTMF tones, an Internet end system is relieved from performing this task and allows an IP phone to emulate DTMF functionality without the burden of generating precise tone pairs and imposing tone recognition on a receiver. A gateway that sends signaling events via RTP may send both named signals and tone representation as a single RTP session, using redundancy to interleave the two representations.

However, under current Internet standards and protocols, there is no voice band protocol for transmitting voice call information such as caller ID and VMWI that are received from the PSTN to an IP phone. Current RTP protocols, such as RFC 2833 enables transmission of digits and hooking events but do not transmit caller ID data. Therefore, many telephone service features that users expect from a PSTN or cellular telephone service provider are not available for IP phones in certain architectures.

### SUMMARY

The shortcomings of conventional protocols for IP phones are overcome by the exemplary embodiment of the present invention that defines an RTP payload format for carrying voice band data transmissions that are used to carry information for telephony services that include Caller Identification (ID), Visual Message Waiting Indication (VMWI), and Advance Digital Subscriber Interface (ADSI) Systems. The present invention extends the payload format for RTP to voice band data transmissions by assigning an event code for voice band data information and defining the packet format.

### BRIEF DESCRIPTION OF THE DRAWINGS

Preferred embodiments of the invention are discussed hereinafter in reference to the drawings, in which:

FIG. 1 illustrates a schematic diagram of a voice over packet network;

FIG. 2 illustrates a typical packet for carrying voice data on a packet network;

FIG. 3 illustrates an RTP message format;

FIG. 4 illustrates an RTP payload format for IP telephony;

FIG. 5 illustrates an IP telephony network using RTP that is connected to a public telephone network;

FIG. 6 illustrates an exemplary embodiment of an RTP payload format for Caller-ID information.

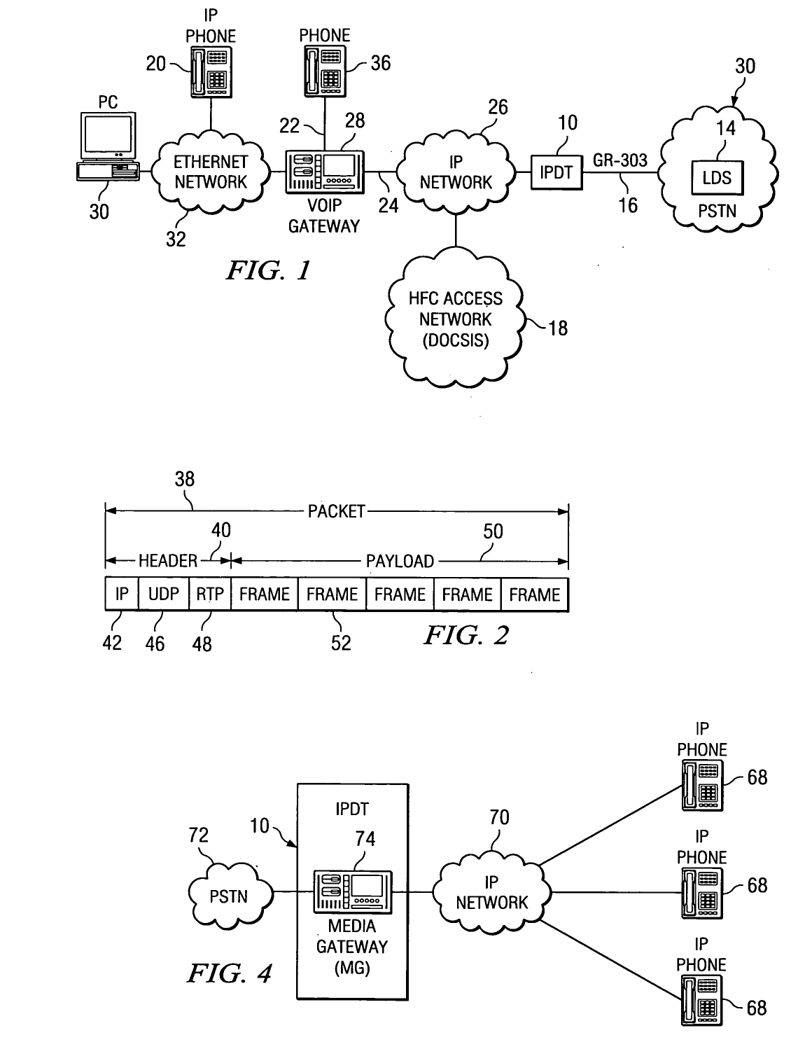

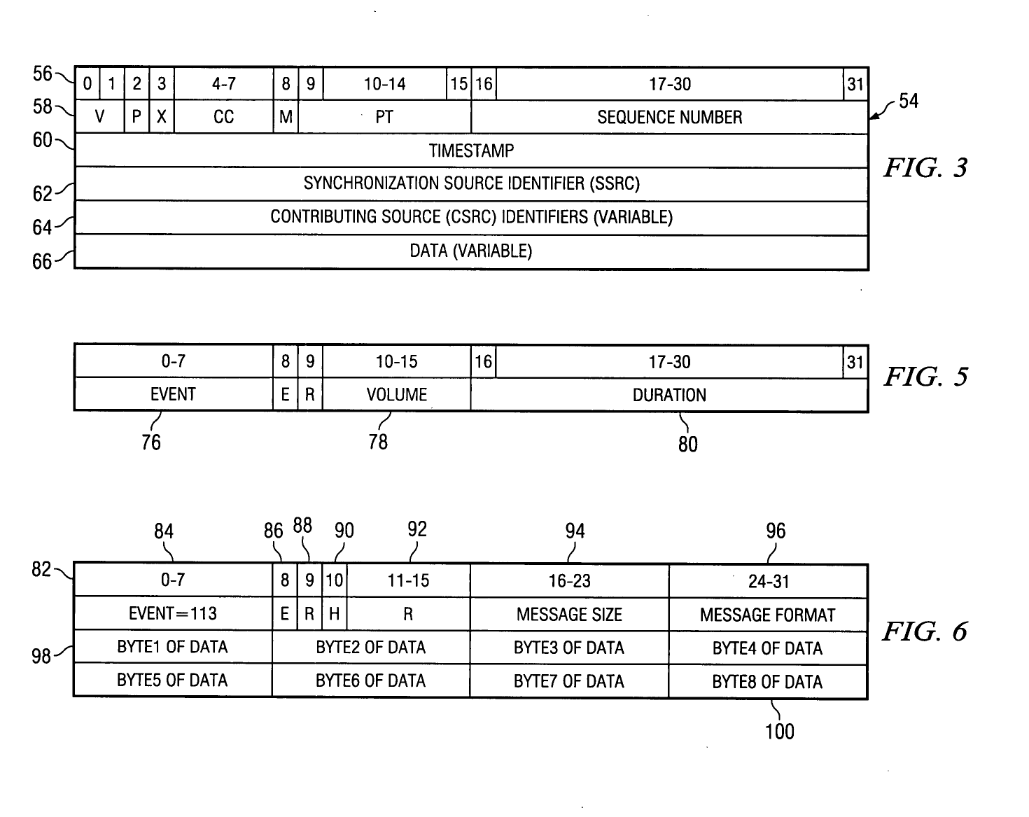

### DETAILED DESCRIPTION OF PREFERRED EMBODIMENTS

For IP telephony architectures, like those making use of GR-303 interfaces and LCS (Line Control Signaling) of PacketCable, which do not have a fully developed signaling or call control mechanism in place, end systems such as “Internet Phones” would have to recognize the voice band data transmissions for applications (e.g., Caller-ID, Visual Message Waiting Indication (VMWI), etc.). Low bit rate voice codecs cannot be guaranteed to reproduce this information accurately enough for automatic recognition. Defining this payload format permits recognition of this data at the public switched telephone network (PSTN) boundary, and therefore accurate reproduction or display at the end system.

FIG. 4 illustrates a diagram of a plurality of IP phones 68 as endpoints connected to a broadband packet network 70. When a telephone call originates from the PSTN 72 to an IP phone 68, the call is received IPDT (Internet Protocol Digital Terminal) 10, which contains a media gateway (MG) 74. The call parameters are controlled by the PSTN 72, including dial tone/ringing, and caller ID. The MG 74 in IPDT 10 is a media gateway for converting call signals from RFC 2833 to TTM telephony protocols. The conversion enables the transmission of DTMF digits and dial tone/ringing and caller ID sent from IP network 70 to PSTN 72. The MG 74 handles PSTN events, maps a telephone number from the PSTN 72 to a particular IP endpoint, and sends a ringing signal over the packet network 70. When an endpoint 68 goes off-hook, the signal is send from the endpoint 68 to the MG 74 which then translates the signal to an appropriate protocol, such as SS7, and sends the signal to the PSTN 72. However, as stated previously, caller ID, VMWI, and other line and trunk signals do not convert from a PSTN call for some codecs once the call is converted by the MG 74. Therefore, certain call features will not be available for an end user at an IP phone 68.

Media gateway 70 converts voice calls originating from PSTN 72 onto the packet network 70 using RTP protocols. The RTP message payload format identifies data formats for network data signals that represent a telephones signals (e.g., dialtones) and events (e.g., off-hook, on-hook). For example, a payload format for telephony events and tones is illustrated in FIG. 5. The Event field 76 identifies the DTMF digits while the volume field 78 shows the power level of a DTMF digit. The power level is set to zero for events other than DTMF digits. The Duration field 80 shows the duration of the DTMF digit.

In defining the payload format for RTP messages, the present invention does not assume a particular message format or encoding rules that are used for the voice band data transmission. Hence, the payload format or encoding rules of the present invention can accommodate message formats used in different countries as long as media gateways and end systems have the capability to understand the data format and may have the capability to convert from one format to another. The Media Gateway detecting the voice band data should signal the format used for correct interpretation by the systems at the opposite end of the transmission. Without imposing any additional structure on the voice band data message, the end systems are spared the burden of translating the voice band data from one format to another for the sake of transporting the data via RTP. At the same time it permits transcoding to other mutually understandable formats for the purpose of transport or regeneration at the opposite end of a transmission.

An exemplary embodiment of the RTP payload format for the present invention is illustrated as a datagram in FIG. 6, which illustrates a payload format for an RTP message carrying Caller-ID information. The top row 82 represents bits of a 32-bit message in numerical order from bits zero to thirty-one. Each 32-bit value is transmitted in the following order: bits 0-7, bits 8-15, bits 16-23, and bits 24-31. This type of transmission is known as big endian byte ordering. The lower rows of payload format datagram represent fields of the message divided according to the total length of each field according to the number of bits each field occupies.

The fields of the payload format for Caller-ID are formatted in the following manner. The Event field 84 occupies bits zero to seven and identifies named events as described in RFC 2833. These events include DTMF named events, data modem and fax events, line events (e.g., ringing tone, off-hook, dial tone), extended line events, and trunk events. In the example, the event code defined in RFC 2833 for voice data transmission is “113,” however the exemplary embodiment may be practiced using one of the unused event codes. The E, or end, bit 86 occupies the eight bit and has the same meaning as the payload format for named events in RFC 2833. The E bit is set to a value of one (1) to indicate if that packet contains the end of the message. If the message must be split into multiple packets for transmission, then the end bit of the last packet of the message is set to one (1). The RTP timestamp and sequence number must be incremented when the message is split among multiple packets.

Referring again to FIG. 6, the R bit 88, 92 occupies bit place nine and bits eleven through fifteen and is reserved for future use. R must be set to zero (0) and the receiver must ignore it. The H bit 90 occupies bit place ten and is set to one (1) if the data transmission was received in the off-hook state or else it is set to zero (0).

The protocol for voice band data transmission differs depending on the hook state at the an endpoint. The end system may make use of this bit if re-generation is required and the hook state of the end system is not known to the DSP subsystem regenerating the message. For end systems such as IP phone that need only to call a display routine, this may not be applicable.

The message size field 94 occupies bits sixteen and twenty-three. The message size 94 defines the total number of bytes of the message included in the packet. If the message was split into multiple packets, then the message size defines the number of bytes included in the packet. The message format field 96 occupies bits twenty-four through thirty-one of the RTP payload format. The message format 96 for North America is set to one (1). For other countries that use different message formats, then the message format field 96 is set to the international dialing code for the country in question (i.e., for Japan the message format 96 is set to decimal 82). Below the payload format layer is the payload of data. Data are divided into bytes labeled Byte1 of Data 98, Byte 2 of Data, etc., continuing to ByteN of Data 100. Data bytes contain voice band data.

Using the RTP payload format described above, an RTP payload format for carrying voice band data transmissions over a packet network is used to carry information for IP phone applications that include Caller Identification (ID), Visual Message Waiting Indication (VMWI), and Advance Digital Subscriber Interface (ADSI) Systems.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A method for providing a real time protocol packet format for voice band data transmissions, comprising:
receiving, into a packet network, voice transmission signals containing a voice band data transmissions for an application from the public switched telephone network;
converting said voice transmission signals into data packets using real time protocol (RTP);
defining an RTP message payload format in said data packets for said voice band data transmissions for an application by assigning an RTP event code in said payload format for said voice band data application.

2. The method of claim 1, wherein the receiving the voice transmission signals containing the voice band data transmissions for an application comprises receiving voice band data transmissions containing a Caller Identification signal.

3. The method of claim 2, further comprising:
displaying, on an endpoint telephony device connected to said packet network, the Caller Identification signal after said data packets containing said RTP message payload format are received into said endpoint device.

4. The method of claim 1, wherein the receiving the voice transmission signals containing the voice band data transmissions for an application comprises receiving voice band data transmissions containing a Voice Mail Waiting Indicator signal.

5. The method of claim 4, further comprising:
displaying, on an endpoint telephony device connected to said packet network, the Voice Mail Waiting Indicator signal after said data packets containing said RTP message payload format are received into said endpoint device.

6. The method of claim 1, wherein the receiving the voice transmission signals containing the voice band data transmissions for an application comprises receiving voice band data transmissions containing a Advanced Digital Subscriber Interface application signal.

7. The method of claim 6, further comprising:
displaying, on an endpoint telephony device connected to said packet network, the Advanced Digital Subscriber Interface application signal after said data packets containing said RTP message payload format are received into said endpoint device.

8. The method of claim 1, wherein said converting said voice transmission signals into data packets comprises converting said voice transmission signals using a voice over Internet Protocol, and
converting said voice transmission signals using Request for Comments 2833 standards.

9. The method of claim 1, wherein said defining comprises defining said voice band data transmissions for an application using one of the unused event codes in an RFC 2833 packet format.

10. A system for providing a real time protocol packet format for voice band data transmissions, comprising:
a packet network to receive voice transmission signals containing a voice band data transmissions for an application from the public switched telephone network;
an Internet Protocol Digital Terminal (IPDT), connected between the packet network and the public switched telephone network, to convert said voice transmission signals into data packets using real time protocol (RTP), and to define an RTP message payload format in said data packets for said voice band data transmissions for an application by assigning an RTP event code in said payload format for said voice band data application.

11. The system of claim 10, wherein the packet network receives voice band data transmissions containing a Caller Identification signal.

12. The system of claim 11, further comprising:
an endpoint telephony device, connected to said packet network, to display the Caller Identification signal after said data packets containing said RTP message payload format are received into said endpoint telephony device.

13. The system of claim 10, wherein the packet network receives voice band data transmissions containing a Voice Mail Waiting Indicator signal.

14. The system of claim 13, further comprising:
an endpoint telephony device, connected to said packet network, to display the Voice Mail Waiting Indicator signal after said data packets containing said RTP message payload format are received into said endpoint telephony device.

15. The system of claim 10, wherein the packet network receives voice band data transmissions containing a Advanced Digital Subscriber Interface application signal.

16. The system of claim 15, further comprising:
an endpoint telephony device, connected to said packet network, to display the Advanced Digital Subscriber Interface application signal after said data packets containing said RTP message payload format are received into said endpoint telephony device.

17. The system of claim 10, wherein said IPDT converts said voice transmission signals into data packets comprises converting said voice transmission signals using a voice over Internet Protocol, and
converts said voice transmission signals using Request for Comments 2833 standards.

18. The system of claim 10, wherein said IPDT defines said voice band data transmissions for an application using one of the unused event codes in an RFC 2833 packet format.
